(19) United States
(12) Patent Application Publication
(10) Pub. No.: US 2017/0321897 A1
(43) Pub. Date: Nov. 9, 2017

(54) MANAGING EMISSION PRODUCED BY A COMBUSTION DEVICE

(71) Applicant: Elwha LLC, Bellevue, WA (US)

(72) Inventors: ALISTAIR K. CHAN, BAINBRIDGE ISLAND, WA (US); HON WAH CHIN, PALO ALTO, CA (US); TOM DRISCOLL, SAN DIEGO, CA (US); W. DANIEL HILLIS, CAMBRIDGE, MA (US); RODERICK A. HYDE, REDMOND, WA (US); MURIEL Y. ISHIKAWA, LIVERMORE, CA (US); JORDIN T. KARE, SAN JOSE, CA (US); CLARENCE T. TEGREENE, MERCER ISLAND, WA (US); CHARLES WHITMER, NORTH BEND, WA (US); LOWELL L. WOOD, JR., BELLEVUE, WA (US); VICTORIA Y.H. WOOD, LIVERMORE, CA (US)

(21) Appl. No.: 15/145,930

(22) Filed: May 4, 2016

(51) Int. Cl. F23N 5/00; F23N 5/08; F23N 5/18

(52) U.S. Cl. CPC F23N 5/003; F23N 5/184; F23N 5/082; G05B 2219/45076

(57) ABSTRACT

Described embodiments include a system, method, and apparatus. The system includes a sensor device configured to measure an unburned fuel component in an exhaust stream generated by a gas-fueled combustion device. The system includes a combustion analysis circuit configured to generate a quality of combustion information responsive to the measured unburned fuel component. The system includes a user interface configured to display the quality of combustion information in a human perceivable format. In an embodiment, the system includes a combustion component controller configured to regulate an aspect of a combustion component delivered to the gas-fueled combustion device in response to the combustion management selection entered by a human user.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)).

### PRIORITY APPLICATIONS

None

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### SUMMARY

For example, and without limitation, an embodiment of the subject matter described herein includes a system. The system includes a sensor device configured to measure an unburned fuel component in an exhaust stream from a gas-fueled combustion device. The system includes a feedback controller configured to generate a combustion management signal responsive to the measured unburned fuel component and to a target value for the measured unburned fuel component. The system includes a combustion controller configured to regulate an aspect of a combustion component delivered to a burner of the gas-fueled combustion device in response to the combustion management signal.

In an embodiment, the system includes a heater configured to preheat the gas fuel before it arrives at the burner in response to the combustion management signal. The combustion management signal includes a specified gas fuel preheat temperature. In an embodiment, the system includes a pre-combustor configured to pre-combust the gas fuel before it arrives at the burner in response to the combustion management signal. The combustion management signal includes a specified ratio of air to gas fuel to be used by the pre-combustor. In an embodiment, the system includes a combustion air preheater configured to preheat the combustion air before it arrives at the burner in response to the combustion management signal. The combustion management signal includes a specified combustion air preheat temperature. In an embodiment, the system includes a user interface configured to display a quality of combustion information responsive to the measured unburned fuel component in a human perceivable format.

For example, and without limitation, an embodiment of the subject matter described herein includes a method. The method includes measuring an unburned fuel component in an exhaust stream from a gas-fueled combustion device. The method includes generating a combustion management signal responsive to the measured unburned fuel component and to a target value for the measured unburned fuel component. The method includes regulating an aspect of a combustion component delivered to a burner of the gas-fueled combustion device in response to the combustion management signal.

In an embodiment, the method includes preheating the gas fuel before it arrives at the burner in response to the combustion management signal, the combustion management signal including a specified gas fuel preheat temperature. In an embodiment, the method includes pre-combusting the gas fuel before it arrives at the burner in response to the combustion management signal. The combustion management signal includes a specified ratio of air to gas fuel to be used by the pre-combustor. In an embodiment, the method includes preheating the combustion air before it arrives at the burner in response to the combustion management signal. The combustion management signal includes a specified combustion air preheat temperature. In an embodiment, the method includes displaying a quality of combustion information responsive to the measured unburned fuel component in a human perceivable format. In an embodiment, the method includes outputting an electronic signal indicative of a quality of combustion information responsive to the measured unburned fuel component in a format usable by a consumer-accessible platform.

For example, and without limitation, an embodiment of the subject matter described herein includes a system. The system includes means for measuring an unburned fuel component in an exhaust stream from a gas-fueled combustion device. The system includes means for generating a combustion management signal responsive to the measured unburned fuel component and to a target value for the measured unburned fuel component. The system includes means for regulating an aspect of a combustion component delivered to a burner of the gas-fueled combustion device in response to the combustion management signal.

In an embodiment, the system includes means for preheating the gas fuel before it arrives at the burner in response to the combustion management signal. The combustion management signal includes a specified gas fuel preheat temperature. In an embodiment, the system includes means for pre-combusting the gas fuel before it arrives at the burner in response to the combustion management signal. The combustion management signal includes a specified ratio of air to gas fuel to be used by the pre-combustor. In an embodiment, the system includes means for preheating the combustion air before it arrives at the burner in response to the combustion management signal. The combustion management signal includes a specified combustion air preheat temperature. In an embodiment, the system includes means for displaying a quality of combustion information responsive to the measured unburned fuel component in a human perceivable format. In an embodiment, the system includes means for outputting an electronic signal indicative of a quality of combustion information responsive to the measured unburned fuel component in a format usable by a consumer-accessible platform.

The foregoing summary is illustrative only and is not intended to be in any way limiting. In addition to the illustrative aspects, embodiments, and features described above, further aspects, embodiments, and features will become apparent by reference to the drawings and the following detailed description.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates an example environment 100 in which embodiments may be implemented;

FIG. 2 illustrates an example operational flow 200 in which embodiments may be implemented;

FIG. 3 illustrates an example system 300 in which embodiments may be implemented;

FIG. 4 illustrates an example environment 400 in which embodiments may be implemented;

FIG. 5 illustrates an example operational flow 500 in which embodiments may be implemented;

FIG. 6 illustrates an example environment 600 in which embodiments may be implemented; and

FIG. 7 illustrates an example operational flow 700 in which embodiments may be implemented.

### DETAILED DESCRIPTION

This application makes reference to technologies described more fully in U.S. patent application Ser. No. 15/145,915, MANAGING EMISSION PRODUCED BY A COMBUSTION DEVICE, naming Alistair Chan et al. as inventors, filed on May 4, 2016, is related to the present application. That application is incorporated by reference herein, including any subject matter included by reference in that application

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various implementations by which processes and/or systems and/or other technologies described herein can be effected (e.g., hardware, software, and/or firmware), and that the preferred implementation will vary with the context in which the processes and/or systems and/or other technologies are deployed. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Hence, there are several possible implementations by which the processes and/or devices and/or other technologies described herein may be effected, none of which is inherently superior to the other in that any implementation to be utilized is a choice dependent upon the context in which the implementation will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures suitable to implement an operation. Electronic circuitry, for example, may manifest one or more paths of electrical current constructed and arranged to implement various logic functions as described herein. In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or otherwise invoking circuitry for enabling, triggering, coordinating, requesting, or otherwise causing one or more occurrences of any functional operations described below. In some variants, operational or other logical descriptions herein may be expressed directly as source code and compiled or otherwise invoked as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar mode(s) of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

In a general sense, those skilled in the art will also recognize that the various aspects described herein which can be implemented, individually and/or collectively, by a wide range of hardware, software, firmware, and/or any combination thereof can be viewed as being composed of various types of “electrical circuitry.” Consequently, as used herein “circuit” or “electrical circuitry” may include, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

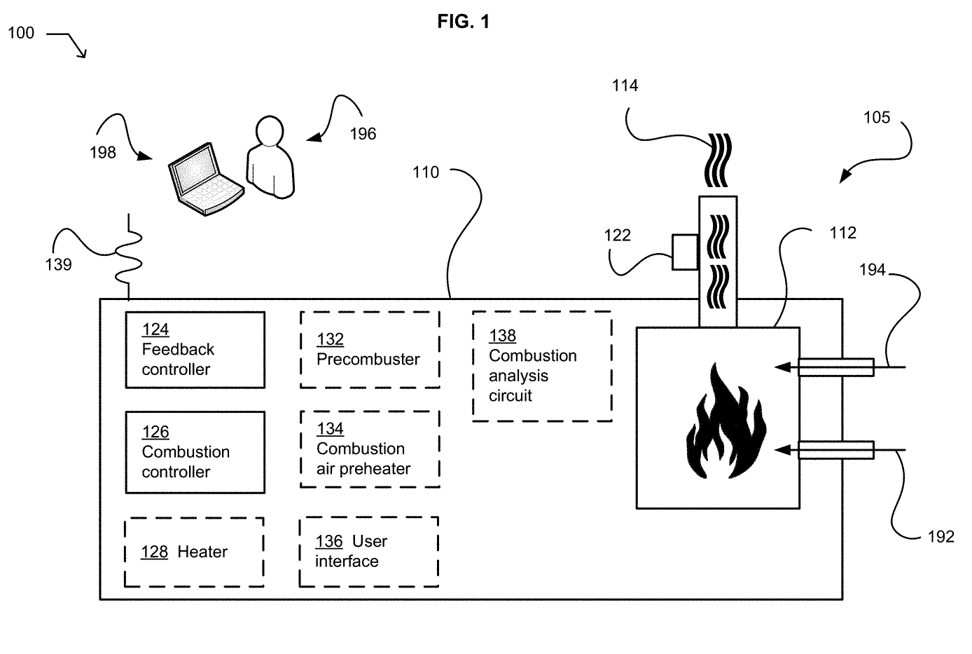

FIG. 1 illustrates an example environment 100 in which embodiments may be implemented. The environment includes a gas-fueled combustion device 105 having a burner 112 and a system 110. The system includes a sensor device 122 configured to measure an unburned fuel component in an exhaust stream 114 from the burner of the gas-fueled combustion device. In an embodiment, the sensor device may be positioned to measure the unburned fuel component from a portion of exhaust stream in a flue of the gas-fueled combustion device. In an embodiment, the sensor device may be positioned to measure the unburned fuel component from a portion of exhaust stream in an open or free space proximate to a flue of the gas-fueled combustion device. The system includes a feedback controller 124 configured to generate a combustion management signal responsive to the measured unburned fuel component and to a target value for the measured unburned fuel component. In an embodiment, the target value of the unburned fuel component may be a selected target value. For example the target value may be selected by a consumer, owner, or operator of the gas-fueled combustion device. In an embodiment, the target value of the unburned fuel component may be specified by a manufacturer of the gas-fueled combustion device. In an embodiment, the target value of the unburned fuel component may be specified by a governmental or regulatory authority. In an embodiment, the target value of the unburned fuel component may be suggested or recommended by an industry association. The system includes a combustion controller 126 configured to regulate an aspect of combustion air 194 delivered to the burner of the gas-fueled combustion device in response to the combustion management signal.

In an embodiment, the sensor device 122 includes a sensor device configured to optically measure an unburned fuel component in an exhaust stream 114. In an embodiment of the system, the measured unburned fuel component includes methane, natural gas, ethane, butane or a propane component in the exhaust stream. In an embodiment, the sensor device includes a sensor device configured to optically measure light emitted by molecules of the unburned fuel component. In an embodiment, the sensor device includes a sensor device configured to beam a light into the exhaust stream causing a fluorescence of gas molecules in the exhaust stream, detecting the fluorescence of the gas molecules in the exhaust stream, and measure an unburned fuel component in response to the detected fluorescence of the gas molecules. In an embodiment, the sensor device includes a sensor device configured to beam an ionic radiation or electron radiation into the exhaust stream causing a fluorescence of gas molecules in the exhaust stream, detecting the fluorescence of the gas molecules, and measure an unburned fuel component in response to the detected fluorescence of the gas molecules. In an embodiment, the sensor device includes a sensor device configured to beam a light through the exhaust stream, detect an absorption or scattering of the beamed light by gas molecules in the exhaust stream, and measure an unburned fuel component in response to the detect absorption or scattering by the gas molecules.

In an embodiment, the sensor device 122 is further configured to measure a combustion reaction product in the exhaust stream. For example, a combustion reaction product may include COx, NOx, or CHy. In an embodiment of the system, the feedback controller 124 is configured to generate a combustion management signal responsive to a measured unburned fuel component, a target value for the measured unburned fuel component, and the measured level of combustion reaction product. In an embodiment of the system, the sensor device is further configured to measure a level of methane in ambient air. In an embodiment of the system, the sensor device is further configured to measure a level of methane in ambient air prior to an ignition of the gas-fueled combustion device. In an embodiment, the feedback controller 124 configured to generate a combustion management signal responsive to a measured unburned methane fuel component, a target value for the measured unburned fuel component, and the measured level of methane in the ambient air.

In an embodiment, the gas-fueled combustion device 105 includes a water heater, dryer, stove top, grill, or oven. In an embodiment, the gas-fueled combustion device includes a household gas-fueled appliance. In an embodiment, the gas-fueled combustion device includes a commercial gas-fueled device. In an embodiment, the gas-fueled combustion device includes an industrial gas-fueled combustion device. In an embodiment, the gas-fueled combustion device includes an open flame gas-fueled combustion device. In an embodiment, the gas-fueled combustion device includes a contained gas-fueled combustion appliance. In an embodiment, the gas fuel 192 includes a methane, natural gas, ethane, butane, or propane gas fuel.

In an embodiment of the feedback controller 124, the combustion management signal includes a specified fuel-air ratio responsive to the measured unburned fuel component. For example, the combustion management signal may control the amount of combustion air 194 mixed with the gas fuel 192. In an embodiment, the measured unburned fuel component includes a measured unburned fuel component. In an embodiment, the combustion management signal includes a specified oxygen-nitrogen composition of the combustion component. In an embodiment, the combustion management signal includes a specified oxygen flow velocity. For example, when oxygen is delivered to the burner 112.

In an embodiment, the combustion management signal includes a specified combustion air feed velocity responsive to the measured unburned fuel component. For example, the combustion management signal may control the velocity of combustion air relative to the gas fuel 192. In an embodiment, the combustion management signal includes a specified combustion gas fuel feed velocity responsive to the measured unburned fuel component. In an embodiment, the combustion management signal includes a selected combustion air feed location. For example, the combustion management signal may control a location or locations of combustion air delivery relative to a gas fuel delivery location. For example, the combustion management signal may supply extra combustion air in sheath around fuel, or downstream of gas fuel. For example, the combustion management signal may control gas fuel or combustion air delivery to a pre-mixer. In an embodiment, the combustion management signal includes a selected gas fuel feed location. In an embodiment, the combustion management signal includes a specified combustion air preheat temperature. For example, the combustion management signal may control a preheating of the combustion air; a preheating of air used to surround combustion gas fuel, or a preheating of air supplied downstream of the gas fuel combustion. In an embodiment, the combustion management signal includes a specified gas fuel flow volume to the burner 112 responsive to the measured unburned fuel component. In an embodiment, the combustion management signal includes a specified gas fuel preheat temperature responsive to the measured unburned fuel component. In an embodiment, the system 110 includes a heater 128 configured to preheat the gas fuel 192 before it arrives at the burner 112 in response to the combustion management signal. The combustion management signal includes a specified gas fuel preheat temperature. In an embodiment, the feedback controller is configured to generate a combustion management signal responsive to at least one of (i) a measured unburned gas fuel unburned fuel component in the exhaust stream 114, (ii) a target value for the measured unburned fuel component, and (iii) a combustion reaction product in the exhaust stream. For example, in this embodiment, the feedback controller is configured to balance pollution against global warming etc. or other long term effects of the unburned fuel component in the exhaust stream when deciding how to modify the combustion process of the combustion device 105.

In an embodiment of the system 105, the combustion component includes the gas-fuel. In an embodiment, the combustion component includes a combustion air component. In an embodiment, the combustion air component includes ambient air, natural air oxygen, or nitrogen. In an embodiment, the combustion component includes an oxidizer.

In an embodiment of the feedback controller 124, the combustion management signal includes a specified ratio of air to gas fuel supplied to a pre-combustor 132. In an embodiment, the system 110 includes the pre-combustor configured to pre-combust the gas fuel 192 before it arrives at the burner 112 in response to the combustion management signal. The combustion management signal including a specified ratio of air to gas fuel to be used by the pre-combustor. In an embodiment, the combustion management signal includes a specified preheating of combustion air 194. For example, the specified combustion air preheating may include a specified combustion air temperature or a specified volume. For example, the specified combustion air preheating may include controlling a flow of the exhaust stream 114 or incident air through a heat exchanger used to preheat the combustion air. For example, the heat may be obtained or sourced from heat of combustion in the burner, or a heat exchanger from the exhaust stream. In an embodiment, the system includes a combustion air preheater 134 configured to preheat the combustion air before it arrives at the burner in response to the combustion management signal. The combustion management signal includes a specified combustion air preheat temperature.

In an embodiment, the system 110 includes a user interface 136 configured to display a quality of combustion information responsive to the measured unburned fuel component in a human perceivable format. In an embodiment, the user interface includes a human-user interface. In an embodiment, the quality of combustion information is responsive to (i) the measured unburned fuel component in a human perceivable format and (ii) the target value for the measured unburned fuel component. In an embodiment, the quality of combustion information includes an indication of a level or a quantification of the measured unburned fuel component in the exhaust stream. For example, the quality of combustion information may include information indicative of emissions of unburned gas fuel. For example, the quality of combustion information may be based on instantaneous values or cumulative values. In an embodiment, the quality of combustion information includes an indication of gas fuel savings. In an embodiment, the quality of combustion information includes an indication of an effect of the combustion management signal in changing or reducing the measured unburned fuel component in the exhaust stream. In an embodiment, the quality of combustion information includes an indication in terms of a greenhouse gas effect of the measured unburned fuel component in the exhaust stream. For example, the quality of combustion information may include a quality or quantity of unburned gas fuel in the exhaust stream 114. For example, the quality of combustion information may include possible environmental impact interrelationships between at least two unburned fuel components in the exhaust stream. For example, the combustion information may indicate that unburned methane has twenty times the adverse environment impact as does CO2. For example, the combustion information may compare the adverse environment impacts of unburned methane and CO2, and suggest in response thereto a combustion management scheme that provides a minimized adverse environment impact. In an embodiment, the quality of combustion information includes a comparison of greenhouse gas effects of the measured unburned gas fuel component relative to that of CO2 components in the exhaust stream. For example, a comparison of greenhouse gas effects may include an indication that the greenhouse effects from unburned methane are 2× times that from the CO2, so please consider the unburned methane as significant. For example, a comparison of greenhouse gas effects may include an indication that the greenhouse effects from unburned methane are 0.1× times that from the CO2, so please do not consider the CO2 level as significant. In an embodiment, the quality of combustion information includes a rate of production of the measured unburned fuel component. In an embodiment, the quality of combustion information includes a comparison of a rate of production of the measured unburned fuel component to the target rate. In an embodiment, the quality of combustion information includes a comparison of a rate production of the measured unburned fuel component to a specified metric. In an embodiment, the quality of combustion information includes a projected production of the measured unburned fuel component over a specified time interval.

In an embodiment, the system 110 includes a combustion analysis circuit 138 configured to output a signal indicative of a quality of combustion information responsive to the measured unburned fuel component in a format usable by a consumer-accessible platform 198. In an embodiment, the consumer-accessible platform includes a mobile consumer-accessible platform. The consumer is illustrated as consumer 196. In an embodiment, the consumer-accessible platform includes a smart phone, a tablet, a laptop computer, or a mobile device. In an embodiment, the consumer-accessible platform includes a web enabled device. In an embodiment, the consumer-accessible platform includes a cellular mobile device. In an embodiment, the consumer-accessible platform includes an application configured to display or share the quality of combustion information. For example, the application may include an application configured to transfer or upload the quality of combustion information to a social media website. In an embodiment, the combustion analysis circuit is configured to wirelessly 139 transmit the signal indicative of a quality of combustion information responsive to the measured unburned fuel component in a format usable by a consumer-accessible platform.

In an embodiment, the feedback controller 124 is configured to generate a combustion management signal responsive to the measured unburned fuel component and a target value for the measured unburned fuel component only if the measured unburned fuel component exceeds a threshold. For example, the feedback controller may be configured to compare the measured unburned fuel component to a threshold level or value of the measured unburned fuel component and remain inactive until the level or value of the measured unburned fuel component is above the threshold. For example, the feedback controller may be configured to implement different management tactics over a range of measured unburned fuel component levels or values. In an embodiment, the feedback controller is configured to generate a combustion management signal responsive to the measured unburned fuel component and a target value for the measured unburned fuel component only if the measured unburned fuel component exceeds a cumulative threshold.

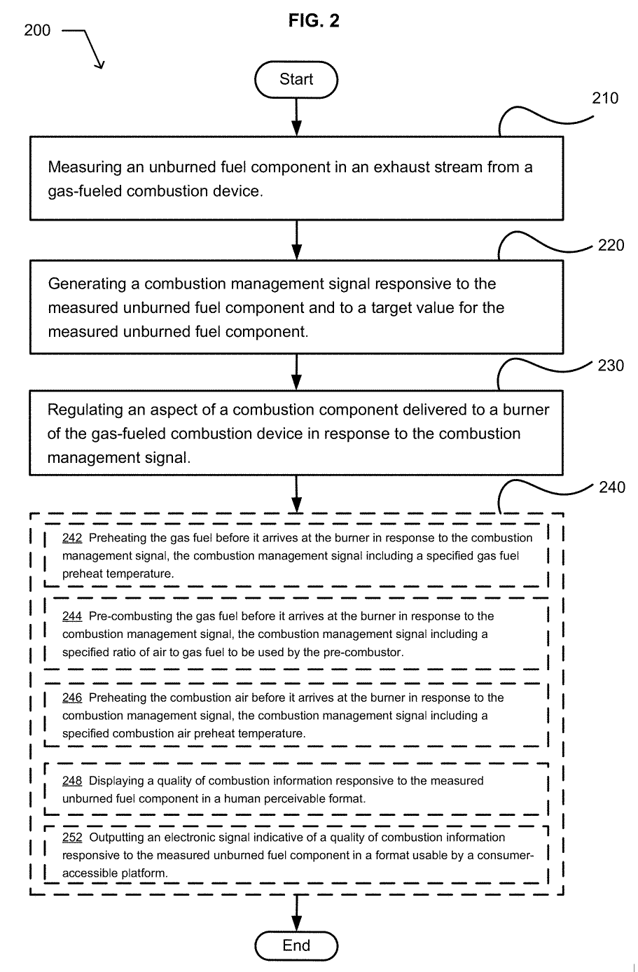

FIG. 2 illustrates an example operational flow 200 in which embodiments may be implemented. After a start operation, the operational flow includes a sensing operation 210. The sensing operation includes measuring an unburned fuel component in an exhaust stream from a gas-fueled combustion device. In an embodiment, the sensing operation may be implemented using the sensor 122 described in conjunction with FIG. 1. A feedback operation 220 includes generating a combustion management signal responsive to the measured unburned fuel component and a target value for the measured unburned fuel component. In an embodiment, the feedback operation may be implemented using the feedback controller 124 described in conjunction with FIG. 1. A control operation 230 includes regulating an aspect of a combustion component delivered to a burner of the gas-fueled combustion device in response to the combustion management signal. In an embodiment, the control operation may be implemented using the combustion controller 126 described in conjunction with FIG. 1. The operational flow includes an end operation.

In an embodiment, the operational flow 200 includes at least one additional operation 240. In an embodiment, the at least one additional operation includes an operation 242 preheating the gas fuel before it arrives at the burner in response to the combustion management signal. The combustion management signal includes a specified gas fuel preheat temperature. In an embodiment, the at least one additional operation includes an operation 244 pre-combusting the gas fuel before it arrives at the burner in response to the combustion management signal. The combustion management signal includes a specified ratio of air to gas fuel to be used by the pre-combustor. In an embodiment, the at least one additional operation includes an operation 246 preheating the combustion air before it arrives at the burner in response to the combustion management signal. The combustion management signal includes a specified combustion air preheat temperature. In an embodiment, the at least one additional operation includes an operation 248 displaying a quality of combustion information responsive to the measured unburned fuel component in a human perceivable format. In an embodiment, the at least one additional operation includes an operation 252 outputting an electronic signal indicative of a quality of combustion information responsive to the measured unburned fuel component in a format usable by a consumer-accessible platform.

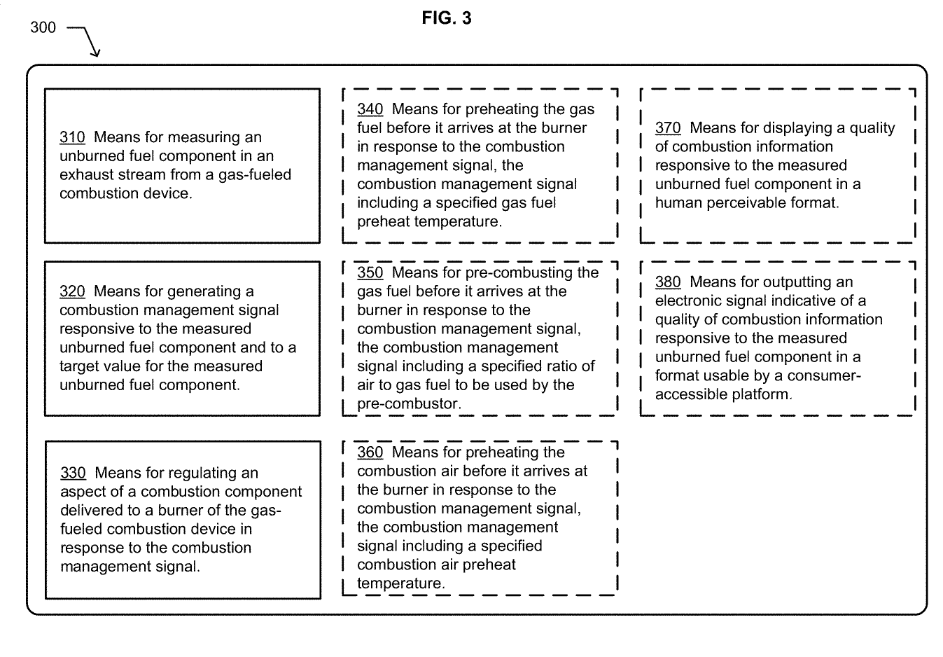

FIG. 3 illustrates an example system 300 in which embodiments may be implemented. The system includes means 310 for measuring an unburned fuel component in an exhaust stream from a gas-fueled combustion device. The system includes means 320 for generating a combustion management signal responsive to the measured unburned fuel component and a target value for the measured unburned fuel component. The system includes means 330 for regulating an aspect of a combustion component delivered to a burner of the gas-fueled combustion device in response to the combustion management signal.

In an embodiment, the system 300 includes means 340 for preheating the gas fuel before it arrives at the burner in response to the combustion management signal, the combustion management signal including a specified gas fuel preheat temperature. In an embodiment, the system 300 includes means 350 means for pre-combusting the gas fuel before it arrives at the burner in response to the combustion management signal. The combustion management signal includes a specified ratio of air to gas fuel to be used by the pre-combustor. In an embodiment, the system 300 includes means 360 for preheating combustion air before it arrives at the burner in response to the combustion management signal, the combustion management signal includes a specified combustion air preheat temperature. In an embodiment, the system 300 includes means 370 for displaying a quality of combustion information responsive to the measured unburned fuel component in a human perceivable format. In an embodiment, the system 300 includes means 380 for outputting an electronic signal indicative of a quality of combustion information responsive to the measured unburned fuel component in a format usable by a consumer-accessible platform.

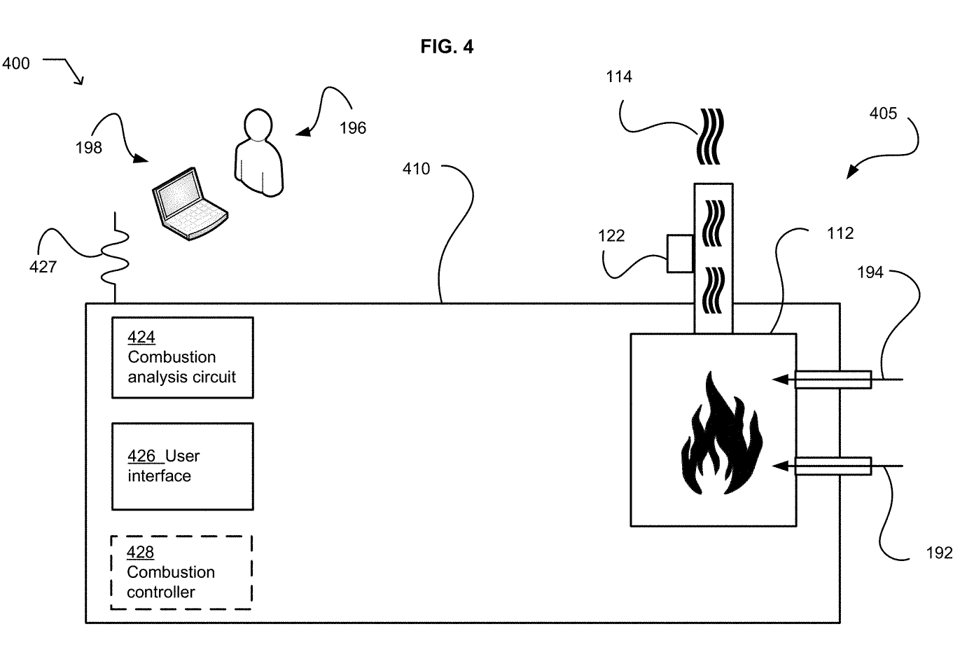

FIG. 4 illustrates an example environment 400 in which embodiments may be implemented. The environment includes a gas-fueled combustion device 405 having a burner 112 and a system 410. The system includes the sensor device 122 configured to measure an unburned fuel component in the exhaust stream 114 generated by the gas-fueled combustion device. In an embodiment, the exhaust stream is generated by the burner 112 of the gas-fueled combustion device. The system includes a combustion analysis circuit 424 configured to generate a quality of combustion information responsive to the measured unburned fuel component. The system includes a user interface 426 configured to display the quality of combustion information in a human perceivable format. In an embodiment, the user interface includes a human-user interface. For example, the user interface may include a display surface, such as an LED display or LCD display. For example, the user interface may include a touch screen.

In an embodiment, the sensor device 122 includes a sensor device configured to optically measure an unburned fuel component in the exhaust stream. In an embodiment, the sensor device is further configured to measure a combustion reaction product in the exhaust stream. In an embodiment of the combustion analysis circuit 424, the quality of combustion information includes quality of combustion information in a human perceivable format and responsive to (i) the measured unburned fuel component and (ii) the target value for the measured unburned fuel component. In an embodiment, the quality of combustion information includes an indication of a level or quantification of the measured unburned fuel component in the exhaust stream 114. In an embodiment, the quality of combustion information includes an indication of gas fuel savings. In an embodiment, the quality of combustion information includes an indication of an effect of the combustion management signal in changing or reducing the measured unburned fuel component in the exhaust stream. In an embodiment, the quality of combustion information includes an indication in terms of a greenhouse gas effect of the measured unburned fuel component in the exhaust stream. In an embodiment, the quality of combustion information includes a comparison of greenhouse gas effect of the measured unburned gas fuel unburned fuel component relative to that of CO2 components in the exhaust stream. In an embodiment, the quality of combustion information includes a rate of production of the measured unburned fuel component. In an embodiment, the quality of combustion information includes a comparison of a rate of production of the measured unburned fuel component to the target rate. In an embodiment, the quality of combustion information includes a comparison of a rate production of the measured unburned fuel component to a specified metric. In an embodiment, the quality of combustion information includes a projected production of the measured unburned fuel component over a specified time interval.

In an embodiment of the combustion analysis circuit user interface 426 is further configured to receive a combustion management selection entered by the human user 196. In an embodiment, the system 400 includes a combustion controller 428 configured to regulate an aspect of a combustion component delivered to the gas-fueled combustion device in response to the combustion management selection entered by the human user.

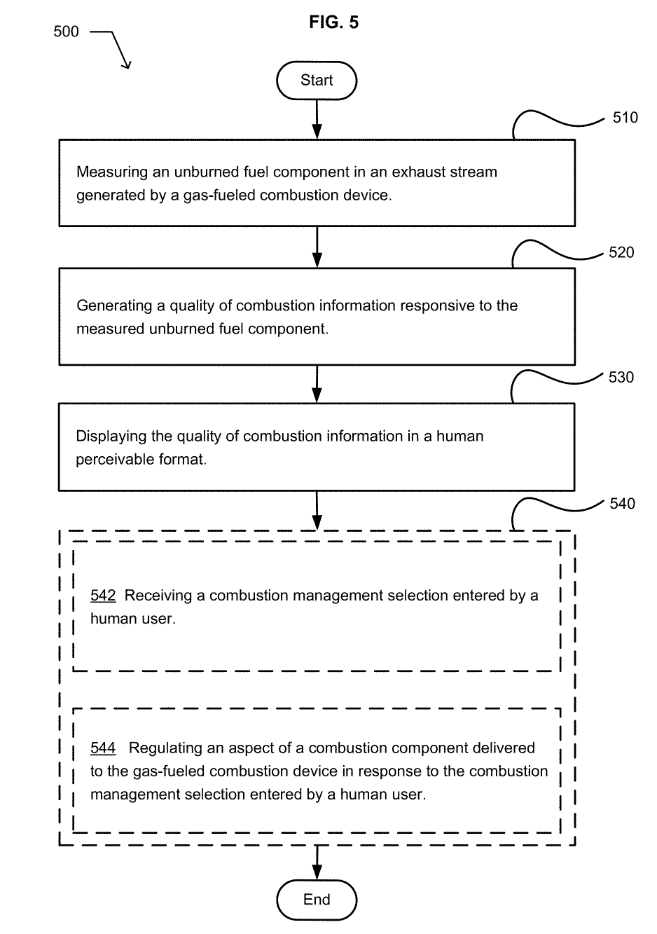

FIG. 5 illustrates an example operational flow 500 in which embodiments may be implemented. After a start operation, the operational flow includes a sensing operation 510. The sensing operation includes measuring an unburned fuel component in an exhaust stream generated by a gas-fueled combustion device. In an embodiment, the sensing operation may be implemented using the sensor 122 described in conjunction with FIGS. 1 and 4. An analysis operation 520 includes generating a quality of combustion information responsive to the measured unburned fuel component. In an embodiment, the analysis operation may be implemented using the combustion analysis circuit 424 described in conjunction with FIG. 4. A presentation operation 530 includes displaying the quality of combustion information in a human perceivable format. In an embodiment, the displaying operation may be implemented using the user interface 426 described in conjunction with FIG. 4. The operational flow includes an end operation.

In an embodiment, the operational flow 500 includes at least one additional operation 540. In an embodiment, the at least one additional operation includes an operation 542 receiving a combustion management selection entered by a human user. In an embodiment, the at least one additional operation includes an operation 544 regulating an aspect of a combustion component delivered to the gas-fueled combustion device in response to the combustion management selection entered by a human user.

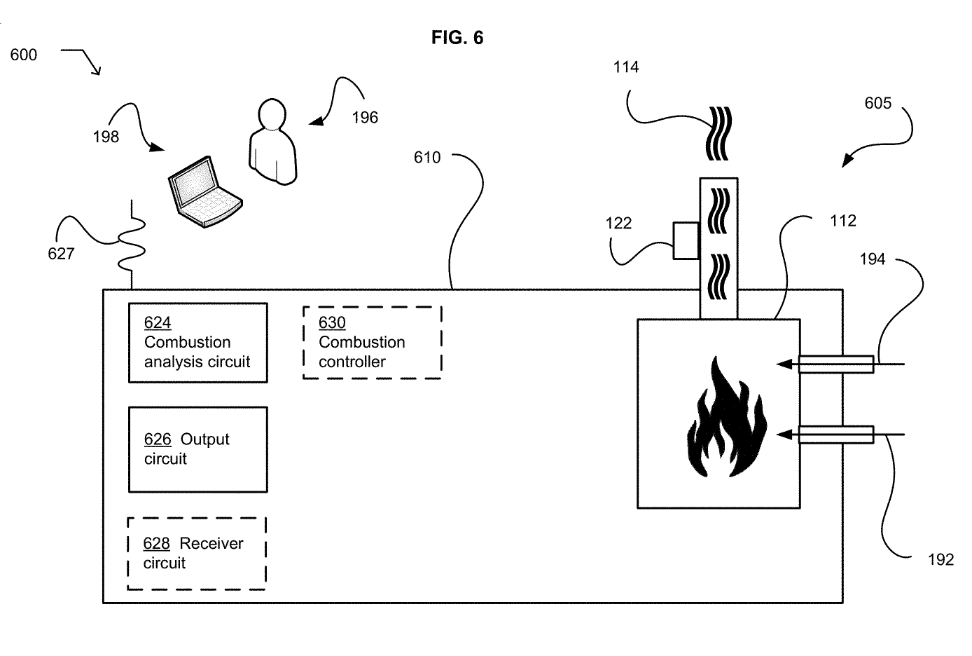

FIG. 6 illustrates an example environment 600 in which embodiments may be implemented. The environment includes a gas-fueled combustion device 605 having a burner 112 and a system 610. The system includes the sensor device 122 configured to measure an unburned fuel component in the exhaust stream 114 generated by the gas-fueled combustion device. The system includes a combustion analysis circuit 624 configured to generate a quality of combustion information responsive to the measured unburned fuel component. The system includes an output circuit 626 configured to transmit the quality of combustion information in a format usable by a consumer-accessible platform 198.

In an embodiment, the consumer-accessible platform 198 includes a platform that includes a processor, display, and user input device. In an embodiment, the consumer-accessible platform includes a computing device. In an embodiment, the consumer-accessible platform includes a web enabled mobile device. In an embodiment, the consumer-accessible platform includes a cellular mobile device.

In an embodiment, the system 610 includes a receiver circuit 628 configured to receive from the consumer-accessible platform 198 a combustion management selection entered by the human user 196. In an embodiment, the system includes a combustion controller 630 configured to regulate an aspect of a combustion component delivered to the gas-fueled combustion device in response to the combustion management selection entered by the human user.

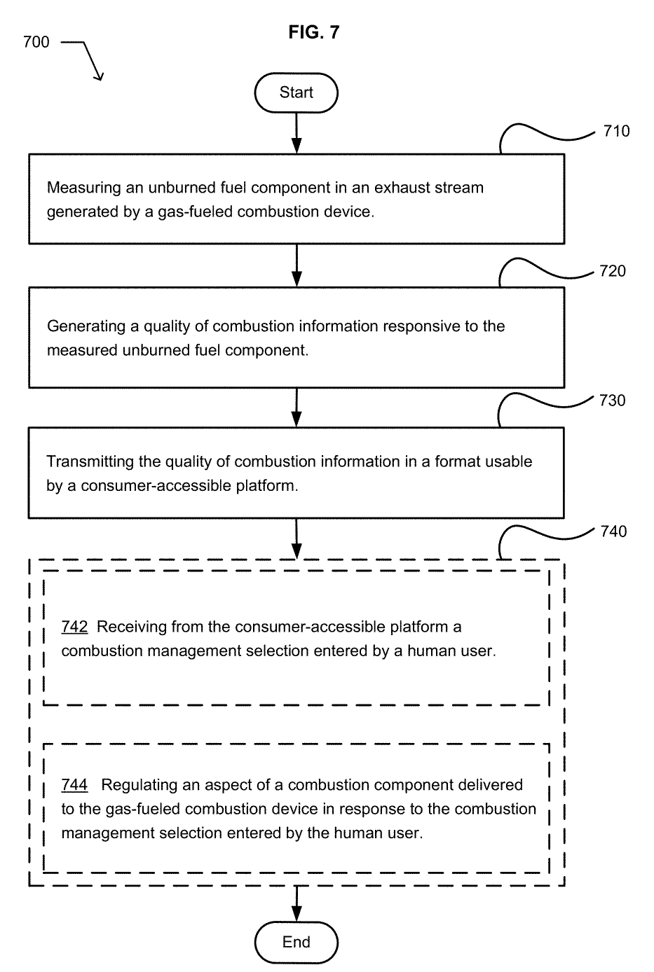

FIG. 7 illustrates an example operational flow 700 in which embodiments may be implemented. After a start operation, the operational flow includes a sensing operation 710. The sensing operation includes measuring an unburned fuel component in an exhaust stream generated by a gas-fueled combustion device. In an embodiment, the sensing operation may be implemented using the sensor 122 described in conjunction with FIG. 1, 4, or 6. An analysis operation 720 includes generating a quality of combustion information responsive to the measured unburned fuel component. In an embodiment, the analysis operation may be implemented using the combustion analysis circuit 424 described in conjunction with FIG. 4 or the combustion analysis circuit 624 described in conjunction with FIG. 6. A communication operation 730 includes transmitting the quality of combustion information in a format usable by a consumer-accessible platform. The communication operation may be implemented using the output circuit 626 described in conjunction with FIG. 6. The operational flow includes an end operation.

In an embodiment, the operational flow 700 includes at least one additional operation 740. In an embodiment, the at least one additional operation includes an operation 742 receiving from the consumer-accessible platform a combustion management selection entered by a human user. In an embodiment, the at least one additional operation includes an operation 744 regulating an aspect of a combustion component delivered to the gas-fueled combustion device in response to the combustion management selection entered by the human user.

All references cited herein are hereby incorporated by reference in their entirety or to the extent their subject matter is not otherwise inconsistent herewith.

In some embodiments, “configured” or “configured to” includes at least one of designed, set up, shaped, implemented, constructed, or adapted for at least one of a particular purpose, application, or function. In some embodiments, “configured” or “configured to” includes positioned, oriented, or structured for at least one of a particular purpose, application, or function.

It will be understood that, in general, terms used herein, and especially in the appended claims, are generally intended as “open” terms. For example, the term “including” should be interpreted as “including but not limited to.” For example, the term “having” should be interpreted as “having at least.” For example, the term “has” should be interpreted as “having at least.” For example, the term “includes” should be interpreted as “includes but is not limited to,” etc. It will be further understood that if a specific number of an introduced claim recitation is intended, such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a receiver” should typically be interpreted to mean “at least one receiver”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “at least two chambers,” or “a plurality of chambers,” without other modifiers, typically means at least two chambers).

In those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, B₁, B₂, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The herein described aspects depict different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable or physically interacting components or wirelessly interactable or wirelessly interacting components.

With respect to the appended claims the recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Use of “Start,” “End,” “Stop,” or the like blocks in the block diagrams is not intended to indicate a limitation on the beginning or end of any operations or functions in the diagram. Such flowcharts or diagrams may be incorporated into other flowcharts or diagrams where additional functions are performed before or after the functions shown in the diagrams of this application. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system comprising:
a sensor device configured to measure an unburned fuel component in an exhaust stream generated by a gas-fueled combustion device;
a combustion analysis circuit configured to generate a quality of combustion information responsive to the measured unburned fuel component; and
a user interface configured to display the quality of combustion information in a human perceivable format.

2. The system of claim 1, wherein the sensor device includes a sensor device configured to optically measure an unburned fuel component in the exhaust stream.

3. The system of claim 1, wherein the sensor device is further configured to measure a combustion reaction product in the exhaust stream.

4. The system of claim 1, wherein the quality of combustion information includes quality of combustion information in a human perceivable format and responsive to (i) the measured unburned fuel component and (ii) the target value for the measured unburned fuel component.

5. The system of claim 1, wherein the quality of combustion information includes an indication of a level or quantification of the measured unburned fuel component in the exhaust stream.

6. The system of claim 1, wherein the quality of combustion information includes an indication of gas fuel savings.

7. The system of claim 1, wherein the quality of combustion information includes an indication of an effect of the combustion management signal in changing the measured unburned fuel component in the exhaust stream.

8. The system of claim 1, wherein the quality of combustion information includes an indication in terms of a greenhouse gas effect of the measured unburned fuel component in the exhaust stream.

9. The system of claim 1, wherein the quality of combustion information includes a rate of production of the measured unburned fuel component.

10. The system of claim 1, wherein the quality of combustion information includes a comparison of a rate of production of the measured unburned fuel component to the target rate.

11. The system of claim 1, wherein the quality of combustion information includes a comparison of a rate production of the measured unburned fuel component to a specified metric.

12. The system of claim 1, wherein the quality of combustion information includes a projected production of the measured unburned fuel component over a specified time interval.

13. The system of claim 1, wherein the user interface is further configured to receive a combustion management selection entered by a human user.

14. The system of claim 13, further comprising:
a combustion controller configured to regulate an aspect of a combustion component delivered to the gas-fueled combustion device in response to the combustion management selection entered by a human user.

15. A method comprising:
measuring an unburned fuel component in an exhaust stream generated by a gas-fueled combustion device;
generating a quality of combustion information responsive to the measured unburned fuel component; and
displaying the quality of combustion information in a human perceivable format.

16. The method of claim 15, further comprising:
receiving a combustion management selection entered by a human user.

17. The method of claim 15, further comprising:
regulating an aspect of combustion air delivered to the gas-fueled combustion device in response to the combustion management selection entered by a human user.

18. A system comprising:
a sensor device configured to measure an unburned fuel component in an exhaust stream generated by a gas-fueled combustion device;
a combustion analysis circuit configured to generate a quality of combustion information responsive to the measured unburned fuel component; and
an output circuit configured to transmit the quality of combustion information in a format usable by a consumer-accessible platform.

19. The system of claim 18, wherein the consumer-accessible platform includes a platform that includes a processor, display, and user input device.

20. The system of claim 18, wherein the consumer-accessible platform includes a computing device.

21. The system of claim 18, wherein the consumer-accessible platform includes a web enabled mobile device.

22. The system of claim 18, wherein the consumer-accessible platform includes a cellular mobile device.

23. The system of claim 18, further comprising:
a receiver circuit configured to receive from the consumer-accessible platform a combustion management selection entered by a human user.

24. The system of claim 23, further comprising:
a combustion controller configured to regulate an aspect of a combustion component delivered to the gas-fueled combustion device in response to the combustion management selection entered by the human user.

25. A method comprising:
measuring an unburned fuel component in an exhaust stream generated by a gas-fueled combustion device;
generating a quality of combustion information responsive to the measured unburned fuel component; and
transmitting the quality of combustion information in a format usable by a consumer-accessible platform.

26. The method of claim 25, further comprising:
receiving from the consumer-accessible platform a combustion management selection entered by a human user.

27. The method of claim 25, further comprising:
regulating an aspect of a combustion component delivered to the gas-fueled combustion device in response to the combustion management selection entered by the human user.
